(19) United States
(12) Patent Application Publication
(10) Pub. No.: US 2004/0262075 A1
(43) Pub. Date: Dec. 30, 2004

(54) Ultrasonic amplifier or horn

(76) Inventor: Francis Frederick Hamilton Rawson, Queniborough, Leicestershire (GB)

Correspondence Address: ECKERT SEAMANS CHERIN & MELLOTT, 600 GRANT STREET, 44TH FLOOR, PITTSBURGH, PA, 15219

(21) Appl. No.: 10/485,724

(22) PCT Filed: Jul. 30, 2002
(86) PCT No.: PCT/GB02/03501

(30) Foreign Application Priority Data
Aug. 3, 2001 (GB) 0119005.7

(51) Int. Cl. G08B 1/00; G10K 1/00

(52) U.S. Cl. 181/141; 181/142

(57) ABSTRACT

A method of making an ultrasonic amplifier (8) comprises shaping the ultrasonic amplifier (8) by forging. This means that an amplifier with a complex shape can be forged in one piece, preventing weaknesses at the joins between different sections of the amplifier. It greatly increases the fatigue resistance of the amplifier (8) and can increase the effectiveness of the amplification.

### DESCRIPTION OF INVENTION

This invention relates to ultrasonic amplifiers or horns, in particular, but not exclusively to a method of making ultrasonic amplifiers or horns.

The invention is particularly concerned with ultrasonic amplifiers which are of complex shape, i.e. which are other than cylindrical, and particularly where the direction of application of the ultrasonic vibrations differs from the direction of vibrations emitted.

An ultrasonic amplifier (also known as an ultrasonic horn or sonotrode) is a high energy half wavelength resonant device having an input face to which ultrasonic energy is applied, and an output face from which ultrasonic energy may be transmitted. Ultrasonic amplifiers are generally made from a metal which is suitable for transmission of ultrasound, being low in absorption. Examples of suitable metals are titanium and aluminium alloys.

The technology relating to such high energy ultrasonic devices is very different from the technology relating to conventional, low energy, ultrasonic devices, such as those used in the medical scanning fields. Considerable stress may be imposed on the metal structure of the ultrasonic amplifier by the high amplitude ultrasound so the materials and manufacturing techniques used are very different.

Conventionally ultrasonic amplifiers are made from a metal alloy by machining one or more component parts from a solid metal bar or bars to the shape desired. The ultrasonic amplifier is then bolted or welded together, the input face being connected to a transducer, usually via a booster, whilst the output face is connected to a further amplifier or a transducer, or both. The advantage of machining the metal is that a wide variety of shapes can be made, quickly, easily and relatively inexpensively. There is generally no need to use further finishing processes.

Difficulty has however been encountered in attempting to reduce the amount of energy absorbed by the ultrasonic amplifier below a specific threshold, and it is recognised that the absorption of ultrasonic energy by the amplifier is both wasteful of energy, results in the creation of unnecessary heat which may on occasion need special provision to remove, and results in an increased rate of failure of the device itself.

Indeed, fatigue related failure of ultrasonic amplifiers are known to be a problem in the ultrasonic industry. Despite significant attempts throughout the ultrasonic industry over the recent years, no significantly useful suggestion has been made which significantly reduces this problem.

According to this invention a method of making an ultrasonic amplifier is provided which comprises shaping the ultrasonic amplifier by forging. An amplifier with a complex shape or with a dimension that is a multiple of half wave lengths may thus be provided either as a single amplifier without joins, or as multiple amplifiers joined together.

This invention involves the recognition that a forging process, used to cause the metal alloy to flow into shape in a controlled manner, is conducive to causing the grain (or lattice) structure of the metal alloy to be aligned in a desired manner. This has two effects. Firstly, since the amplification is in-line with the grain structure or lattice of the metal alloy the metal is subjected to less stress and the device has a greatly increased effective fatigue resistance. This enables higher amplitudes of vibration to be used; The device is likely to have particularly enhanced fatigue strength at higher amplitudes of vibration. Secondly, the grain structure or lattice of the metal alloy is aligned in a manner which is conducive to producing full resonance of the amplifier at its desired frequency. Since the grain structure or lattice of the forged horn may be appropriately shaped, the amplification may be more effective.

Specifically, it has been found that by the use of a forging process in which metal is caused to flow in the direction of propagation of ultrasound within the body of the amplifier, i.e. in a grain direction, a significant reduction in the energy absorbed by the amplifier may be achieved, increasing its performance, and increasing the life of the amplifier itself. Conversely, it has been found that when a similar shape is machined from a solid block, on the other hand, the grain structure or lattice maintains the shape and alignment that it had as the block.

The amount of machining necessary may be reduced, reducing the cost of such an amplifier. Additionally, far less scrap may be generated by a forging process than in machining the material from a solid block, which makes the ultrasonic amplifier considerably less expensive.

Preferably the method involves multiple forging operations. The method may also involve inspecting the amplifier and modifying subsequent operations accordingly.

The method may also involve finishing the ultrasonic amplifier by a machining operation. Techniques such as spark erosion, milling, turning or grinding may be used. These finishing techniques smooth the external surface of the amplifier. Preferably the method of forging used is drop forging.

The invention is particularly useful for high energy ultrasonic amplifiers, specifically those operating at an energy of greater than 100 watts. The invention may however be used to advantage in relation to ultrasonic amplifiers operation at a lower energy, eg. in the range 50-100 watts, and may indeed produce measurable improvement in-performance in ultrasonic amplifiers operating in the range 5-50 watts.

The invention is particularly useful in relation to ultrasonic amplifiers which are of complex shape, ie. non-cylindrical, and in particular those ultrasonic amplifiers which are adapted to vary the direction of transmission of the ultrasonic energy, for example, which are adapted to receive ultrasonic energy such as from a transducer in an axial direction, and to transmit ultrasonic energy in a direction extending transverse to said axis, eg. radially.

Specifically, it has been found that such complex ultrasonic amplifiers are particularly prone to malfunction at areas where the ultrasonic energy is transmitted across the grain structure, eg. when the direction of transmission of the ultrasonic energy changes from the axial direction to a transverse direction, tending to produce “hot spots”, and tending to cause disruption of the crystalline structure of the amplifier.

If the grain structure can be made to follow the shape of formations of the ultrasonic amplifiers, for example, slots, holes, or daughter horns, the fatigue strength of the ultrasonic amplifier will be maximised at these particularly vulnerable regions. This is particularly effective when, as is often the case, these are also nodal regions, and so have a relatively large amplitude of vibration;

The invention is particularly suitable for use where the metal alloy used is a titanium alloy. The cost of titanium makes use of this method particularly attractive.

The ultrasonic amplifier may have formations, such as holes or slots, which are formed in either the external or the internal surface of the ultrasonic horn, either as part of the forging process or the subsequent machining process or both.

This invention extends to an ultrasonic amplifier made according to any of the methods outlined above; It also extends to two such ultrasonic amplifiers which are joined-together and which have metal grain boundaries or lattices that are aligned across the region of the join. A plurality of such amplifiers, aligned at each join, may be provided.

Preferred embodiments of ultrasonic amplifiers, selected by way of example, will now be described, with reference to the following drawings in which:

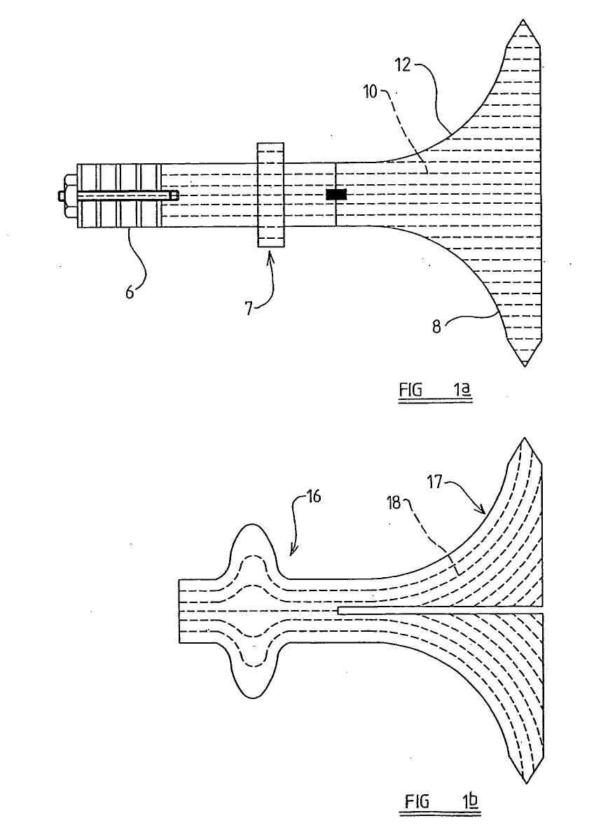

FIG. 1a shows schematically a side view of a conventional ultrasonic device;

FIG. 1b shows schematically a side view of one embodiment of a one piece ultrasonic amplifier made by forging;

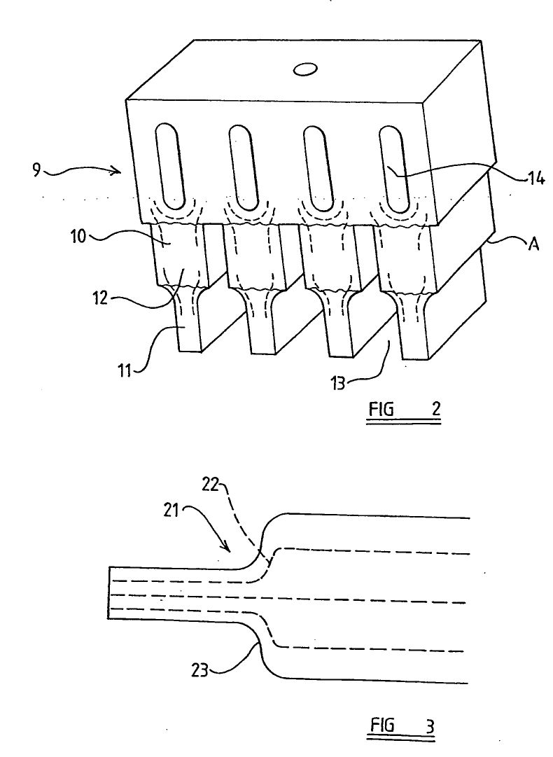

FIG. 2 shows schematically a perspective view of a second embodiment of an ultrasonic amplifier made by forging;

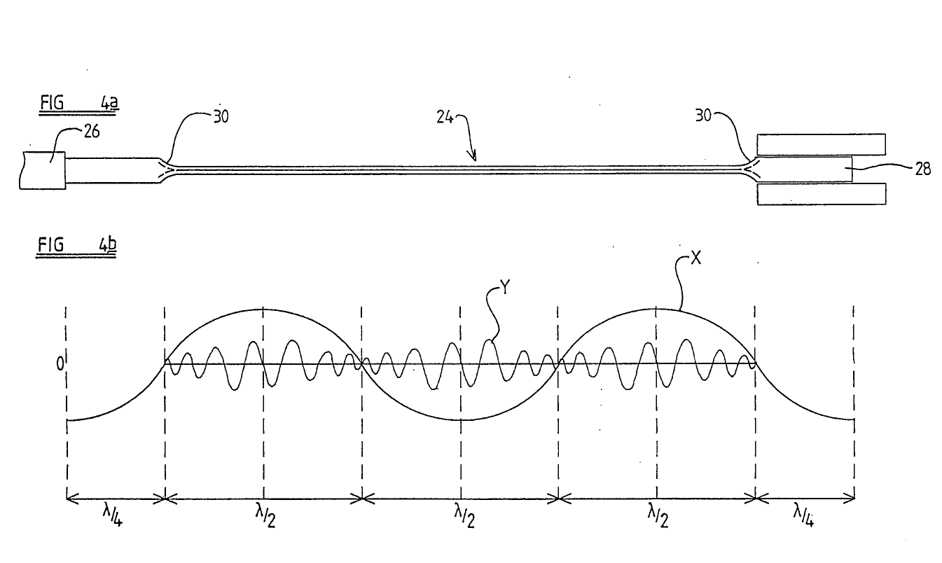

FIG. 3 shows schematically a section view of a nodal region of the embodiment of FIG. 2 in greater detail;

FIG. 4a shows schematically a top view of a third embodiment of an ultrasonic amplifier made by forging; and

FIG. 4b shows the vibrations present in the embodiment of FIG. 4a.

FIG. 1a shows schematically a side view of a conventional ultrasonic device comprising a transducer 6, a first amplifier 7 and a second amplifier 8 all made by machining. Both of the amplifiers 7, 8 are machined from a solid bar. The second amplifier 8 is designed to convert axial vibrations into radial vibrations, as described in GB 2 282 559 which the reader is referred to for further details.

The structure and alignment of the metal grain structure or lattice, shown at 10 is still generally linear, it does not follow the contours of the curved sides 12 of the amplifier. The two amplifiers are simply bolted together.

A more effective axial to radial amplifier is shown in FIG. 1b. The amplifier comprises a first amplifier 16 and a second amplifier 17, which are made from-a single metal billet. Since the billet is forged into an appropriate. shape its grain structure or lattice is aligned with its external contours. The first amplifier 16 corresponds to a conventional booster flange 7, and the second amplifier 17 corresponds to a conventional flared amplifier 8. The two amplifiers 16, 17 are both manufactured by drop forging from a single metal billet. The drop forging process will be described below.

First a billet is cut from a metal bar. The billet may then be heated, preferably in a vacuum, to make the metal more malleable. Two dies, each formed to shape a part of, usually half of, the amplifier are then brought together repeatedly and rapidly. The amplifier is forged by a series of these operations which gradually change its shape. As the external shape of the metal is gradually deformed, so the grain structure or lattice 18 of the metal gradually changes during the forging operations. When the forging operation is complete, the grain structure or lattice 18 is to an extent parallel to the flared sides 16 of the amplifier. The grain or lattice is, therefore, aligned with the direction of vibration.

The device will, therefore, withstand higher amplitude vibrations enabling greater amplification to be achieved. The increased strength of the material enables it to resist fatigue. The device also has increased resistance to heat in the direction of vibration.

The scrap is then removed and the amplifier is finished to its required dimensional tolerances by machining. Grinding then takes place to produce a good surface finish.

The final, forged amplifier resonates along its grain structure and so has a much greater ability to resist fatigue induced cracking, since the grain structure is aligned with the direction of vibration. This also allows much higher amplitudes of vibration to be achieved, indeed the amplifier amplifies the ultrasonic vibrations far more effectively, especially at higher amplitudes of vibration. At the axial part of the transducer the grain structure and the ultrasonic vibrations are in the axial plane whilst at the radial part of the amplifier the lattice structure and the ultrasonic vibrations are in the radial plane.

Since the amplifier is forged in one piece weaknesses caused by joining multiple pieces is eliminated. Forging in one piece also greatly increases the effectiveness and efficiency of ultrasound transmission between the first amplifier and the second amplifier reducing mechanical inefficiencies and heat generation otherwise created at the join.

Since the billet deforms to the shape required only a small amount of excess titanium is needed, and the process is far less wasteful than conventional machining from a blank.

FIG. 2 shows schematically a second embodiment of a forged amplifier 19. This amplifier 19 may be manufactured by a similar process to that outlined above. The figure illustrates the considerable amount of structure that may be impressed in the amplifier by drop forging, or by other forging processes. Probes 20 may be manufactured which have a thinner working end, or daughter amplifier, 11 than supporting end, or mother amplifier, 12.

In this manner the shape of the amplifier, including the shaped working ends 11, the gaps 13 between them, and the slots 14 may be formed in a manner which maximises suitable grain orientation, particularly in nodal regions. This maximises the fatigue strength of the horn. Since the amplifier is more resistant to fatigue the working ends 11 may be made thinner than otherwise advisable, if desired. Alternatively, or additionally, a higher amplitude of ultrasound may be used.

FIG. 3 shows in greater detail the section view showing the grain structure of the horn at point A. The region 21 is a nodal region, or flange, in this particular design of horn, and is therefore subject to a high level of stress and vulnerable to fatigue cracking. However, as may be seen in FIG. 3, the grain (or lattice) structure 22 of the metal material follows its external contour 23, which enhances the fatigue strength of-the ultrasonic amplifier 19.

FIG. 4 shows schematically an ultrasonic cutting device 24 which is driven from both ends 26, 28, and FIG. 4b shows the vibrations present in the device in use. In particular a trace X shows the longitudinal vibrations present whilst Y shows additional transverse vibrations which are present in such devices at the cutting edge. The cutter 24 is described generally in my patent GB 2 325 192. The high amplitude of vibration and the two directions in which the vibrations are directed means that fatigue failure is particularly problematic in such devices, with failure usually occurring at the curved portions 30 of the cutter 24. By forging the ultrasonic cutting device 24 the grain structure at this portion 30 is aligned with the exterior shape, leading to the advantages which have been discussed previously.

It will be appreciated that in ultrasonic amplifiers such as those described above the metal grain structure is controlled by the forging process. Many resonant ultrasonic devices may benefit from being shaped by forging, for example sieves, crucibles, mixers, processors, slicers or razors could all be made using these methods. Many variations and improvements on the devices outlined will occur to the skilled reader, which are included in the scope of the invention outlined herein.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate,. may, separately, or in any combination of such features, be utilised for realising the invention in diverse forms thereof.

1. A method of making an ultrasonic amplifier comprising
shaping the ultrasonic amplifier by forging.

2. A method according to claim 1 involving multiple forging operations.

3. A method according to claim 1 including
finishing the ultrasonic amplifier by a machining operation.

4. A method according to claim 1 including
the method of forging used is drop forging.

5. A method according to claim 1 including
the metal alloy is a titanium alloy.

6. A method according to claim 1 including
the ultrasonic amplifier has a complex shape.

7. A method according to claim 6 in which the ultrasonic amplifier has internal formations.

8. A method according to claim 1 including
the direction of application of ultrasonic vibrations to the amplifier is different from the direction of vibrations emitted.

9. (cancelled).

10. A plurality of ultrasonic amplifiers, each made according to the method of any preceding claim which are joined together, and which have metal grain structures, which are desirably aligned across the region of each join.

11. (cancelled).

12. A method according to claim 2 including
finishing the ultrasonic amplifier by a machining operation.

13. A method according to claim 2 including
The method of forging used is drop forging.

14. A method according to claim 2 including
the metal alloy is a titanium alloy.

15. A method according to claim 2 in which the ultrasonic amplifier has a complex shape.

16. A method according to claim 2 including
the direction of application of ultrasonic vibrations to the amplifier is different from the direction of vibrations emitted.

17. A method according to claim 5 including
the method of forging used is drop forging.

18. A method according to claim 5 including
the metal alloy is a titanium alloy.

19. A method according to claim 5 including
the ultrasonic amplifier has a complex shape.

20. A method according to claim 5 including
the direction of application of ultrasonic vibrations to the amplifier is different from the direction of vibrations emitted.

21. A method according to claim 4 including
the ultrasonic amplifier has a complex shape.

22. A method according to claim 21 including
the direction of application of ultrasonic vibrations to the amplifier is different from the direction of vibrations emitted.
